(19) United States
(12) Patent Application Publication
(10) Pub. No.: US 2004/0022954 A1
(43) Pub. Date: Feb. 5, 2004

(54) Method for forming multilayered coating film

(76) Inventors: Takeaki Tsuda, Shinjuku-Ku (JP); Hiroshi Yoshiba, Shinjuku-Ku (JP)

Correspondence Address: Parkhurst & Wendel, Suite 210, 1421 Prince Street, Alexandria, VA, 22314-2805, US

(21) Appl. No.: 10/399,942

(22) PCT Filed: Aug. 23, 2001
(86) PCT No.: PCT/JP02/08536

(30) Foreign Application Priority Data
Aug. 28, 2001 (JP) 2001-257679

(51) Int. Cl. B05D 1/36

(52) U.S. Cl. 427/402

(57) ABSTRACT

Coating liquids (A) and (B) containing a plurality of organic solvents are previously multilayered on an inclined slide surface 2. The multilayered coating liquids (A) and (B) are transferred onto a substrate 4 to make a multilayered coating film. A coating liquid, which has a mixture ratio of a true solvent and other solvents higher than a ratio at which a gelation starts, is used as the coating liquid (B) for making a lower layer. Thus, a clearly separated multilayered coating film can be achieved without a boundary face between layers being blurred because of solvent diffusion, even when the coating liquids have low viscosity.

### FILED OF THE INVENTION

The present invention relates to a multilayered coating method for forming a multilayered coating film by previously multilayering a plurality of coating liquids on an inclined slide surface, and then transferring the multilayered coating liquids onto a substrate.

### BACKGROUND OF THE INVENTION

A so-called multilayered coating method is conventionally known for forming a plurality of layers on a running substrate by a single coating process. The method is widely utilized for the coating process of photographic film and so on.

In the above multilayered coating method, when using coating liquids containing an organic solvent, each relative density and surface tension of the coating liquids is controlled. However, as shown on the left side of FIG. 3, although a multilayered film composed of coating liquids (A) and (B) can be obtained in a coating step, it is difficult to finally form a uniform multilayered film when the liquids (A) and (B) have low viscosity. This is because solvent diffusion causes the boundary face between the layers of coating liquids (A) and (B) to be blurred, as shown on the right side of FIG. 3.

### SUMMARY OF THE INVENTION

The present invention is made in view of the above disadvantage, and an object thereof is to provide a multilayered coating method using coating liquids containing an organic solvent, in which a boundary face between layers is prevented from being blurred because of a solvent diffusion, even when the coating liquids have low viscosity.

A multilayered coating method according to the present invention comprises the steps of: preparing a coating liquid for a lower layer and a coating liquid for an upper layer; making the lower layer coating liquid and the upper layer coating liquid to be multilayered on an inclined slide surface; and transferring the multilayered lower layer coating liquid and upper layer coating liquid onto a substrate; wherein the lower layer coating liquid consists of a true solvent, other solvents, and a resin component; the upper layer coating liquid consists of a true solvent and a resin component; and a mixture ratio of the true solvent and other solvents of the lower layer coating liquid is a ratio at which a gelation can start.

In the multilayered coating method, a boiling point of the true solvent of the upper layer may be lower than that of the true solvent of the lower layer.

In the multilayered coating method, a dynamic surface tension of the upper layer may be lower than that of the lower layer.

In the multilayered coating method, a viscosity of the upper layer may be higher than that of the lower layer.

### BRIEF DESCRIPTION OF THE DRAWINGS

FIG. 1 is an illustrational view showing schematically a multilayered coating method according to the present invention;

FIG. 2 is a view showing a process of a multilayered coating method according to the present invention; and

FIG. 3 is an illustrational view showing a multilayered film composed of two kinds of coating liquids before drying, and the boundary face therebetween which is blurred after drying.

### DETAILED DESCRIPTION OF THE INVENTION

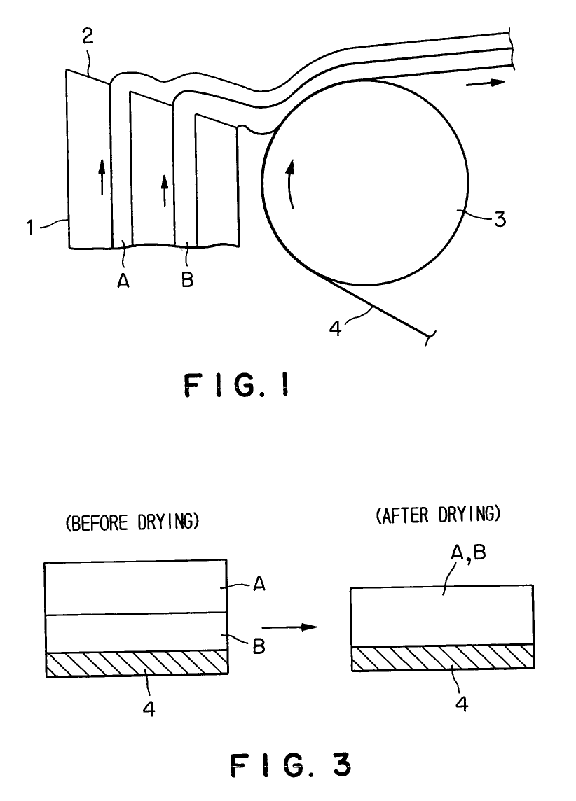

In a multilayered coating method according to the present invention, as shown in FIG. 1, a coating liquid for an upper layer (A) and a coating liquid for a lower layer (B) are prepared. The coating liquids (A) and (B) are extruded through a plurality of narrow slits of a coating head 1 to flow onto an inclined slide surface 2 by gravitation. The overlapped coating liquids (A) and (B) are then transferred onto a running substrate 4 which is mounted on a cooling roll 3 so that a multilayered coating film is obtained.

In this coating method, the coating liquids composed mainly of an aqueous gelatin are generally used. The specific gravity and surface tension of each coating liquid are changed such that the layers of multilayered film are not mixed with each other after the layers of these liquids are overlapped in a single coating, and cooled to be gelled. For example, as shown in FIG. 1, a two-layer coating film is made on the inclined surface 2 by the coating liquids (A) and (B), heated to about 40 to 50° C. and discharged from the coating head 1. The coating film is transferred onto the substrate 4 mounted on the cooling roll 3 cooled to about 10 to 15° C. so as to be gelled. The gelled coating film is then sent to a drying machine.

An embodiment of the present invention is hereinafter described.

The present invention utilizes the fact that a solubility of a resin to be used as a coating film material differs depending on a kind of organic solvent. For example, solution properties of a urethane resin (resin component) with respect to each solvent to be used are shown in the following table 1.

TABLE 1

| | Solution Property of |
|---|---|
| Solvent | Urethane Resin |
| MEK (methyl ethyl ketone) | soluble |
| MIBK (methyl isobutyl ketone) | |
| toluene | partially soluble |
| ethyl acetate | |
| methyl alcohol | insoluble |
| ethyl alcohol | |
| IPA (isopropyl alcohol) | |

An example of a two-layer coating by using the coating liquids (A) and (B) based on the properties shown in the table 1 is hereinafter described. A coating liquid which has a urethane resin as a resin component dissolved in MEK as a true solvent is used as a coating liquid (A) for making an upper layer. A coating liquid which has a urethane resin dissolved in a mixed solvent of MEK, toluene, and IPA is used as a coating liquid (B) for making a lower layer, with an added amount of MEK being adjusted so that gelation is almost likely to start. That is, in the coating liquid (B), MEK is a true solvent and the coating liquid (B) becomes gelled when decreasing the concentration of the true solvent.

The upper layer coating liquid (A) has a lower dynamic surface tension than that of the lower layer coating liquid (B). The upper layer coating liquid (A) has a higher viscosity than that of the lower layer coating liquid (B). When the coating liquid for making an upper layer has a lower dynamic surface tension and a higher viscosity, a clearly separated two-layer coating film can be achieved.

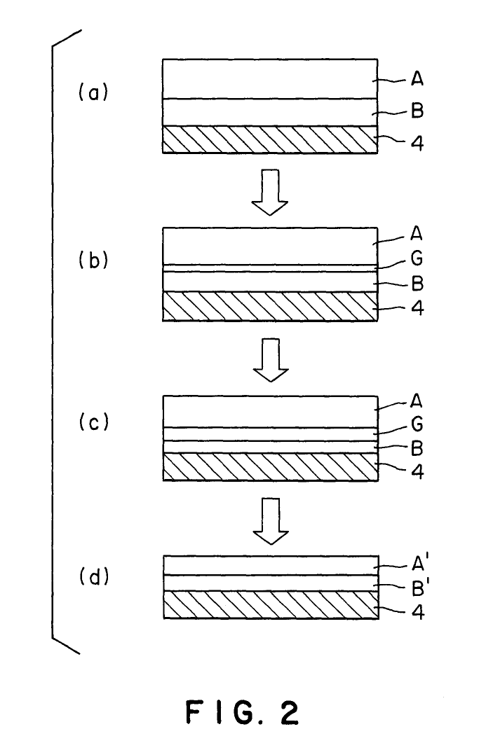

As shown in FIG. 1, the coating liquids (A) and (B) are extruded through a plurality of narrow slits of the coating head 1 to flow onto the inclined slide surface 2 by gravitation. The overlapped coating liquids (A) and (B) are then transferred onto the running substrate 4 which is mounted on the cooling roll 3. Immediately after the coating, the coating liquid (A) is simply overlapped on the lower layer coating liquid (B), as shown in FIG. 2(a). When the concentration of MEK on the surface of the coating liquid (A) is decreased as a drying step starts, MEK is diffusedly moved from the lower layer coating liquid (B) to the coating liquid (A). At this time, the concentration of MEK on a boundary face (interface) of the coating liquid (B) with the coating liquid (A) is decreased so as to make a gelled layer (G), as shown in FIG. 2(b). As shown in FIG. 2(c), the gelled layer (G) gradually spreads downward with the decrease of the MEK concentration in the coating liquid (B). Then, toluene and IPA of the coating liquids (A)(B) are evaporated so that the coating liquids (A)(B) finally become a film. In this way, two-layer coating films (A′) and (B′) can be obtained on the substrate 4, as shown in FIG. 2(d).

When MEK is used as a true solvent of the lower layer coating liquid (B), and MIBK having a lower boiling point than that of MEK is used as a true solvent of upper layer coating liquid (A), a gelation can be induced more easily because a relative diffusion speed is accelerated.

Although an embodiment of the present invention is described above in detail, the multilayered coating method according to the present invention is not limited thereto. Various changes and modifications can obviously be made without departing from the scope of the invention.

In a multilayered coating method according to the present invention using coating liquids containing an organic solvent, a coating liquid for making a lower layer has a mixture ratio of a true solvent and other solvents which is higher than a ratio at which a gelation starts. Thus, a clearly separated multilayered coating film can be achieved without a boundary face between layers being blurred because of solvent diffusion, even when the coating liquids have low viscosity. Accordingly, a multifunctional product can be obtained, as well as a variety of functions can be provided to the formed coating film.

1. A multilayered coating method comprising the steps of:
preparing a coating liquid for a lower layer and a coating liquid for an upper layer;
making the lower layer coating liquid and the upper layer coating liquid to be multilayered on an inclined slide surface; and
transferring the multilayered lower layer coating liquid and upper layer coating liquid onto a substrate;
wherein
the lower layer coating liquid consists of a true solvent, other solvents, and a resin component;
the upper layer coating liquid consists of a true solvent and a resin component; and
a mixture ratio of the true solvent and other solvents of the lower layer coating liquid is a ratio at which a gelation can start.

2. A multilayered coating method according to claim 1, wherein
a boiling point of the true solvent of the upper layer is lower than that of the true solvent of the lower layer.

3. A multilayered coating method according to claim 1 or 2, wherein
a dynamic surface tension of the upper layer is lower than that of the lower layer.

4. A multilayered coating method according to claim 3, wherein
a viscosity of the upper layer is higher than that of the lower layer.
